(19) United States
(12) Patent Application Publication
(10) Pub. No.: US 2023/0241879 A1
(43) Pub. Date: Aug. 3, 2023

(54) AUTO IMAGE REGISTRATION USING A PRINTER SYSTEM CONFIGURED FOR PRINTING ON SUBSTRATE HAVING AT LEAST ONE WIRELESS COMMUNICATION DEVICE

(71) Applicant: Avery Dennison Retail Information Services LLC, Mentor, OH (US)

(72) Inventors: Alberto MORELLI, San Benedetto del Tronto (IT); Carlo DE FELICE, Ascoli Piceno (IT); Andrea FELICIONI, Spinetoli (IT); Mathieu DE BACKER, Grottammare (IT)

(21) Appl. No.: 18/002,783

(22) PCT Filed: Jun. 29, 2021
(86) PCT No.: PCT/US2021/039713

§ 371 Date: Dec. 21, 2022

Related U.S. Application Data
(60) Provisional application No. 63/045,494, filed on Jun. 29, 2020.

(51) Int. Cl. B41F 13/02; B41F 17/00; B41F 13/00; B41M 1/26

(52) U.S. Cl. CPC B41F 13/025; B41F 13/0008; B41F 17/003; B41M 1/26

(57) ABSTRACT

In some embodiments, a printer system may include a location sensor, a motor and driver assembly configured for adjusting a print position of a subsequent image on a substrate having a first side and a second side and at least one wireless communication device, and an optical sensor. Adjustment of the print position may be based on detection of the wireless communication device using the location sensor and a subsequent determination of whether the corresponding printed image is properly aligned with the wireless communication device using the optical sensor.

### CROSS-REFERENCE TO RELATED APPLICATION(S)

The present application claims the benefit of U.S. Provisional Pat. Application No. 63/045,494 filed Jun. 29, 2020, which is incorporated herein by reference in its entirety.

### FIELD OF THE INVENTION

The present invention relates generally to printed images on substrates or manufactured goods. More particularly, the present subject matter relates to improved image placement and registration.

### BACKGROUND

In various industries, images may be printed on a variety of substrates for the fashion market. These images may include certain indicia like words, logos, trademarks, designs, patterns, graphics, artwork, and combinations thereof. However, standard printing equipment for fabric material may not have the ability to align images properly on material that stretches and deforms even during the manufacturing process. Alignment becomes particularly difficult when the target is based on an additional object or mark that is embedded or attached to the material. As a result, due to changes in material and/or the manufacturing process, conventional systems may require the assistance of a person who can manually check for errors and make adjustments to the manufacturing process.

In view of these conventional technologies, the need therefore remains for an improved printing process with more precise placement or registration. There also exists in the art a long felt need for image printing that can be easily or effectively adjusted.

### SUMMARY

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

In some embodiments, a printer system may include a location sensor, a motor and driver assembly configured for adjusting a print position of a subsequent image on a substrate having a first side and a second side and at least one wireless communication device, and an optical sensor. Adjustment of the print position may be based on detection of the wireless communication device using the location sensor and a subsequent determination of whether the corresponding printed image may be properly aligned with the wireless communication device using the optical sensor.

In some embodiments, the printed image may include indicia that may include at least one word, a logo, a trademark, a design, a pattern, a graphic, an artwork, or combinations thereof. The substrate may include a fabric material. The substrate may include fabric, paper, cardboard, laminate, polypropylene, polyester, aluminum, plastic bags, wood, or combinations thereof. The first side of the substrate may be on a side opposite to that of the second side of the substrate.

In some embodiments, the sensor may include a capacitive sensor. The sensor may include a photocell sensor. The sensor may include an optical sensor. The sensor may include a software based sensor. The wireless communication device may include an RFID (radio frequency identification) device, a Near-Field Communication (NFC) device, a Bluetooth device, or combinations thereof. The RFID device may include one or more antennas including a booster antenna woven into the substrate. At least one of the one or more antennas may be coupled to an RFID chip. The wireless communication device may be at least partially attached to the back side of the substrate by an adhesive.

In some embodiments, the wireless communication device may be integrated into the substrate. The sensor, the motor and driver assembly and the optical sensor are installed on a printer of the printer system. The optical sensor may be configured with predetermined specifications of the image to be printed.

In some embodiments, the optical sensor may compare the previous alignment of the image printed with the predetermined specifications of the image to identify alignment or misalignment of the image with respect to the wireless communication device. The motor and driver assembly may align the image with the wireless communication device and within the print register based on the identification of off-centering of the image with respect to the wireless communication device.

In some embodiments, a method of adjusting a position of an image to be printed, with respect to a position of a wireless communication device on a substrate, the method may include providing a printer system may include: a location sensor, a motor and driver assembly, and an optical sensor. The method may include feeding a substrate integrated with at least a portion of a wireless communication device including one or more antennas into a printer of the printer system, and printing an image on a first side of the substrate, the first side being opposite a second side of the substrate, the antenna being at least partially attached to the second side.

The method may include determining a position of the wireless communication device on the substrate using the location sensor. The method may include determining alignment of the image printed with respect to the wireless communication device on the substrate using the optical sensor, and

The method may include adjusting alignment of a following image to be printed on the substrate using the motor and driver assembly.

In some embodiments, the printed image includes indicia may include at least one word, a logo, a trademark, a design, a pattern, a graphic, an artwork, or combinations thereof. The substrate may include a fabric material. The substrate may include fabric, paper, cardboard, laminate, polypropylene, polyester, aluminum, plastic bags, wood, or combinations thereof. The sensor may include an optical sensor. The sensor may include a capacitive sensor. The sensor may include a photocell sensor. The sensor may include a software based sensor.

In some embodiments, the wireless communication device may include RFID (radio frequency identification) device, Near-field communication (NFC), Bluetooth, or combinations thereof. The RFID device may include one or more antennas including a booster antenna woven into the substrate.

In some embodiments, at least one antenna of the one or more antennas may be coupled to a RFID chip. The wireless communication device may be at least partially attached to the back side of the substrate by an adhesive. The wireless communication device may be integrated into the substrate. The printed image may be analyzed on a printer. The printer may be in operation while the printed image may be analyzed.

In some embodiments, the adjustment in the alignment of the following image to be printed may be made when position of the wireless communication device and the printed image may be off-center by less than 5 mm. The adjustment in the alignment of the following image to be printed may be made when print position of the wireless communication device and the printed image may be off-center by less than 3 mm. The adjustment in the alignment of the following image to be printed may be made when print position of the wireless communication device and the printed image may be off-center by less than 2 mm. The adjustment in the alignment of the following image to be printed may be made when print position of the wireless communication device and the printed image may be off-center by more than 5 mm. The adjustment in the alignment of the following image to be printed may be made when the wireless communication device and the printed image are more than 3 mm off-center. The adjustment in the alignment of the following image to be printed may be made when the wireless communication device and the printed image are more than 2 mm off-center.

Other features and advantages of the present invention will become apparent to those skilled in the art from the following detailed description. It is to be understood, however, that the detailed description of the various embodiments and specific examples, while indicating preferred and other embodiments of the present invention, are given by way of illustration and not limitation. Many changes and modifications within the scope of the present invention may be made without departing from the spirit thereof, and the invention includes all such modifications.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary diagram showing a partial perspective view of a printer system configured to analyze a printed image on a substrate according to some embodiments;

FIG. 2 is an exemplary diagram showing a partial perspective view of the printer system according to some embodiments;

FIG. 3 is an exemplary diagram showing a bottom view of a web substrate according to some embodiments;

FIG. 4A is an exemplary drawing showing a top view of a printed image on the web of substrate when a print position has advanced and a corresponding roller adjustment, according to some embodiments.

FIG. 4B is an exemplary drawing showing a top view of a printed image on the web of substrate when a print position has retreated and a corresponding roller adjustment, according to some embodiments.

FIG. 4C is an exemplary drawing showing a top view of a printed image on the web of substrate when a print position is sufficiently aligned and a corresponding roller adjustment, according to some embodiments

FIG. 5A illustrates a top view of a portion of substrate 204 in which the image 205 is printed in accordance with some embodiments.

FIG. 5B illustrates a top view of a folded portion of substrate 204 printed with an image in accordance with some embodiments.

FIG. 6 illustrates a diagram of a printing system, according to some embodiments.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted to avoid obscuring the relevant details of the invention. Further, to facilitate an understanding of the description, discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation. In addition, any feature of an embodiment discussed below may be used alone or in combination with any one or more of the features discussed below.

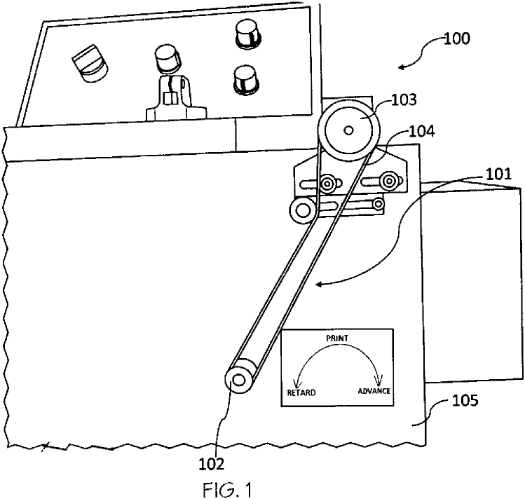

With reference to the drawings, FIG. 1 to FIG. 3 illustrate how some embodiments of the printer system 100 operates. As shown in FIG. 1, the printer system 100 for analyzing a printed image and adjusting a successive image to be printed onto a substrate may include a motor and driver assembly 101, a position sensor 201, and an optical sensor 202 (e.g., a camera, an optical recognition device, a video camera). In various embodiments, the position sensor 201 may be configured to detect an object or image (e.g., an RFID device), such as through capacitance, RFID transmission, magnetism, through use of an optical sensor or image recognition system. In some embodiments, the printer system 100 may be configured to trigger the operation of the vision sensor 202 based on successful detection of the object or image. In various embodiments, operation of the printing system 100 is controlled using one or a combination of one or more processors, programmable logic devices, programmable logic controllers, ASIC, integrated circuits, computers, servers, mobile devices, and a software application.

In various embodiments, the motor and driver assembly 101, the position sensor 201 and the vision sensor 202 may be installed on a printer 105 of the printer system 100. The printer system 100 comprising the printer 105, the motor and driver assembly 101, the position sensor 201 and the vision sensor 202 may be connected to a power supply. Power supply requirements may vary depending on the power drawn by the various components of the system. In some embodiments, the printer 105 is or includes a Flexographic printer or a rotary printer.

In many embodiments, the printer 105 is configured to print on a substrate provided with a wireless communication device such as a RFID (radio frequency identification) device, or a Near-Field Communication (NFC) device, a Bluetooth device, or combinations thereof. In some embodiments, the wireless communication device is a RFID device. The printer 105 may be fed from a roll of substrate 204 containing one or more wireless communication devices 301, which may be embedded into tags, cloth, clothing articles, or other materials or objects. In various embodiments, the substrate 204 may be formed from one of or a combination of two or more of any of the following: chiffon, cotton, crepe, nylon, polyester, crepe, denim, lace, leather, linen, satin, rubber, silk, spandex, lycra, elastane, polyurethane, velvet, wool, or other materials used for clothing, apparel, hats, shoes, pants, jackets, shirts, labels, or tags.

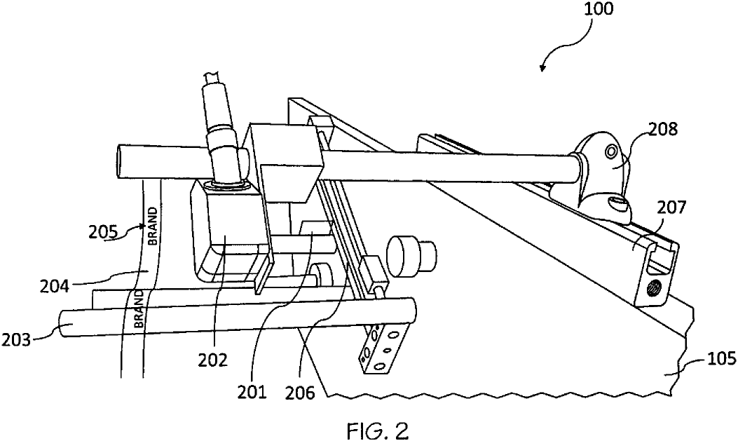

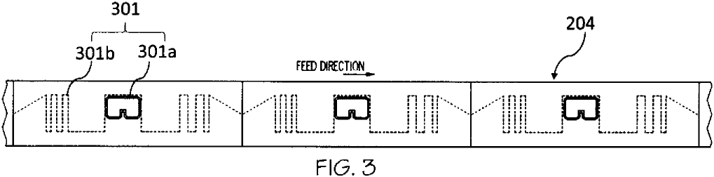

In some embodiments and as shown in FIG. 2 and FIG. 3 the substrate 204 may be a fabric material. Fabric material can inherently be difficult to print upon due to its flexible nature, which can stretch, compress, distort, expand, or otherwise shift or move depending on exerted forces and the construction of the fabric material. Moreover, if the printing is to be done over or near a wireless communication device 301 disposed in and/or on the fabric material, printing may need to overcome an additional challenge of accurately printing over or near the wireless communication device 301 so that no component is damaged during the process and so that the relative positions are correct.

In various embodiments, pulling on the substrate 204 may cause the substrate 204 to elongate in the pulled direction and to shorten in a perpendicular direction to the direction of pulling. Pulling on the substrate 204 may also cause the material to become thinner. Deformation of the substrate may be elastic or plastic. Printing on the substrate 204 while it is under tension may cause the printed image to contract when the tension has been released or reduced.

In various embodiments, pulling on the substrate 204 while it is held within a printer system 100 may cause the thinning, stretching, and/or perpendicular contraction effects described above. In some embodiments, such effects may be held until additional material has been pulled from a source (e.g., a roll) supplying the substrate 204.

In some embodiments, the printer 105 may be fed with a substrate 204, which may be made of fabric material. The wireless communication device 301 may be at least partially attached to the substrate 204, which may include an RFID device including an antenna 301a and/or a booster antenna 301b. For example, the antenna 301a and/or the booster antenna 301b may be woven into the fabric substrate and/or may be disposed on a second side (e.g., a back, bottom, opposite, or internal side) of the substrate 204. For example, the wireless communication device 301 may be embedded between two layers of cloth forming the substrate 204, and stitching may be used to hold the wireless communication device 301 in a pocket. In some embodiments, thread, stitching, or fabric pieces may be used to cover parts of the wireless communication device 301, which may be bound by the thread, stitching, or fabric pieces to the substrate 204. In some embodiments, in addition to or as an alternative to the above described methods, an adhesive may be used to attach the wireless communication device 301 to the substrate. In many embodiments, the adhesive may be comprised of at least one of the following: (a) a hot melt adhesive; (b) a water based adhesive; (c) a solvent based adhesive; (d) an acrylic adhesive; (e) an epoxy adhesive; (f) a rubber adhesive; (g) a silicone adhesive; and (h) a polyurethane adhesive. In some embodiments, the adhesive may be comprised of a pressure sensitive adhesive.

In some embodiments, the antenna 301a and the booster antenna 301b may be provided in or on other substrates that are attached or otherwise combined with the substrate 204 to create or form wireless communication device 301. The other substrates may be formed from materials such as such as paper, cardboard, plastic, cloth, metal, wood, laminate, and combinations thereof. In some embodiments, the other substrate may be chosen from one of or a combination of different plastic materials.

In some embodiments, the substrate 204 may be passed over a return pin 203 extending from a front, side or other surface of the printer 105. The presence of the return pin 203 may help cause the substrate 204 to extend in a plane that faces the position sensor 201. In many embodiments, the position sensor 201 includes a capacitive sensor. In some embodiments, the position sensor 201 may include a photocell sensor, or an optical sensor. In other embodiments, other types of sensors may be included, such as magnetic, pressure, temperature, or RFID sensing devices. For example, a sensor including an RFID reader may be able to communicate with the RFID device if the RFID device is sufficiently close to the sensor.

In some embodiments, the position sensor 201 may be supported on the front surface of the printer 105 by means of a support member 206 attached to the front or side surface of the printer 105. The position sensor 201 may be either permanently or temporarily attached to the printer 105. The position sensor 201 may include a software based sensor and may be configured to detect the position of the antenna 301a and the booster antenna 301b as the substrate 204 passes a detection location. For example, the substrate 204 may pass through a limited area within range of the position sensor 201. In some embodiments, the position sensor 201 may include a capacitive sensor configured to detect a change in capacitance when the antenna component 301a is within range of the position sensor 201 (e.g., when the wireless communication device 301 is within a threshold distance away from the position sensor 201), detects the position of each antenna component 301a present across the length of the roll, as the roll passes over the return pin 203.

In various embodiments, the substrate 204 may include one or more wireless communication devices 301, such as attached to a back side or second side of the substrate 204. In various embodiments, a first side or a front side of the substrate 204 or a material mounted to or above a first side or a front side of the substrate 204, may be printed with an image or indicia 205. In some embodiments, the image 205 is viewable from a side of the substrate 204 that is opposite to the side where the wireless communication device 301 can be viewed. In some embodiments, the image 205 and the wireless communication device 301 are viewable from the same side of the substrate 204. In some embodiments, one or both of the wireless communication device 301 and the image 205 are not visible from either side of the substrate 204, such as when one or both of the wireless communication device 301 and the image 205 are covered by other materials, layers, have different colors or inks, etc. For example, the image 205 may be visible using ultraviolet light, or may react to other environmental conditions.

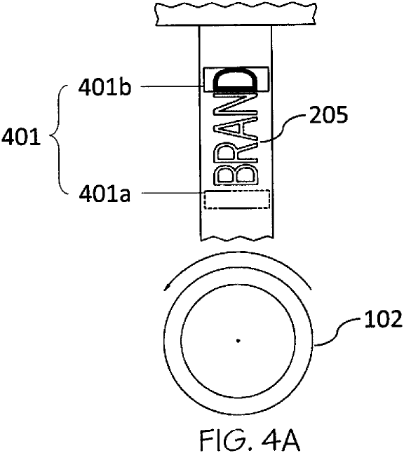

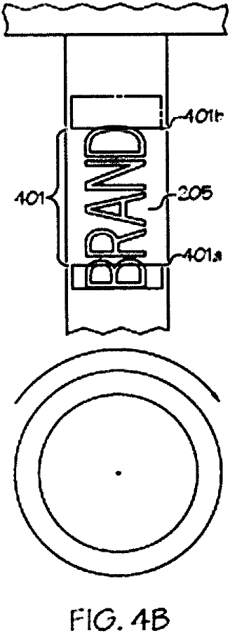

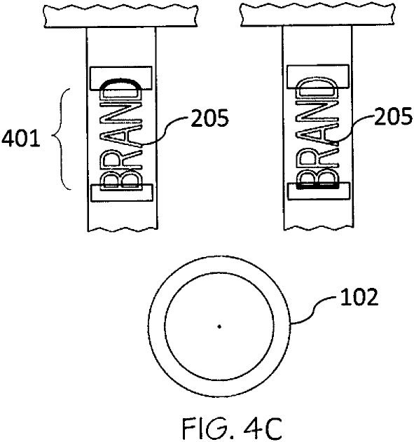

In various embodiments, an accurate print position for the image 205 may be consistently maintained throughout the course of printing multiple images 205 along the length of the substrate 204. The image 205 may be aligned in a manner such that it is printed adjacent to and/or over at least a portion of the wireless communication device 301. In order to achieve the same, it is essential to continuously monitor the position of the wireless communication device 301 and the print position of the image 205 as the substrate 204 passes through the printer 105 and is subjected to tension. A dynamic adjustment in the alignment of the image 205 with the wireless communication device 301 has to be made by monitoring how the image has been previously printed, whether the image is in-line or off-center with respect to the wireless communication device 301. Also, the print position of the image 205 with respect to a register 401 (shown in FIG. 4A) has to be verified.

The vision sensor 202 provided in the printer system 100 detects a position of an image previously printed on the substrate 204. FIG. 2 illustrates the vision sensor 202 as supported on the printer 105 in accordance with some embodiments. A rigid support member 207 installed on a top surface of the printer 105 receives a bracket member 208. The bracket member 208 in turn holds up the vision sensor 202 at an elevation to enable monitoring of the image 205 printed on the substrate 204 as the printed substrate exits the printer 105. The vision sensor 202 linked to a software detects an early or late phase shift of the image printed with respect to the position of the wireless communication device 301. For example, FIG. 4A denotes an early phase shift of the image 205, wherein a portion of the image is printed significantly beyond a second marking 401b of the register 401. The early phase shift typically occurs when a print position selected on position indicator 106 of the printer 105 is “ADVANCE”. FIG. 4B denotes a late phase shift of the image 205, wherein a portion of the image is printed significantly beyond a first marking 401a of the register 401. The late phase shift typically occurs when a print position selected on the position indicator 106 of the printer 105 is “SLOW”. Accordingly, since the vision sensor 202 detects the position of the image previously printed on the substrate 204, feedback provided by the vision sensor 202 to a computer (not shown) of the printer system 100 can be used to make adjustments in print position of a following image. The vision sensor 202 is configured with predetermined specifications of the image to be printed. Based on comparison with the predetermined specifications, the vision sensor 202 may be used to recognize whether the printed image is aligned or off-center with respect to the antenna 301a of the wireless communication device 301 and/or with respect to the register 401.

In various embodiments, such as illustrated in FIG. 1, the motor and driver assembly 101 of the printer system 100 may be configured to make adjustments in the position of the image 205 to be printed. In many embodiments, the motor and driver assembly 101 comprises a motor 102 connected to a driver 103 by means of a pulley 104. The driver 103 in turn may be connected to a PLC (not shown) and/or a computer (not shown). The computer may be in turn connected to the position sensor 201 (shown in FIG. 2) and/or the vision sensor 202. Based on the feedback from the position sensor 201 and the vision sensor 202, the motor and driver assembly 101 may be configured to automatically adjust a position of an image 205 to be printed.

For example, in various embodiments, registration may be detected by intrusion of printed matter into one or both of a first field 401a and a second field 401b, one or both of which may compose the register 401. Determination of whether the image is acceptably placed, too far forward, or too far back may be determined by evaluating how far into one of the first field 401a or the second field 401b the image extends. The threshold for intrusion into one or both of the first field 401a or the second field 401b may be less than 0.1, 0.3, 0.5, 0.7, 0.9, 1, 1.5, 2, 2.5, 3, 3.5, 4, 4.5, 5, 5.5, 6, 6.5, 7, or 7.5 mm into the first field 401a or the second field 401b. In some embodiments, the threshold for intrusion may be less than 1%, 5%, 10%, 15%, 20%, 25%, 30%, 35%, 40%, 45%, 50%, 55%, 60%, or 65% into the first field 401a or the second field 401b.

In some embodiments, if the threshold has been crossed into the first field 401a and the image is too far forward, then the printer system 100 may automatically cause the motor 102 to rotate to slow down movement of the substrate 104 or to draw the substrate 104 back from a direction in which the substrate is being advanced. In some embodiments, if the threshold has been crossed into the second threshold 401b, the printer system 100 may automatically cause the motor 102 to rotate to accelerate movement of the substrate through the printer system 100 or to draw the substrate 104 forward in a direction that the substrate is moving through the printer system 100.

For example, in some embodiments, rotation of the motor 102 may slow down or speed up a drive roller of the printer system 100 that is used to cause movement of the substrate 104. In some embodiments, rotation of the motor 102 may drive rotation of an additional roller that causes the substrate to stretch and/or slide with respect to a drive roller of the printer system 100, either forward or back. In some embodiments, rotation of the motor 102 may drive rotation of a printer roller of a flexographic printer to cause adjustment of a print location relative to the substrate 104. In various embodiments, adjustment of the substrate 104 and/or a print roller may affect subsequently printed images rather than causing correction or change with respect to the evaluated image.

In many embodiments, the image 205 printed is indicia comprising at least one word, a logo, a trademark, a design, a pattern, a graphic, an artwork, or combinations thereof. The image may be applied using digital or inkjet inks, thermal inks, ultraviolet fluorescing inks, or combinations thereof. In many embodiments, the image may be applied using water-based inks or solvent-based inks.

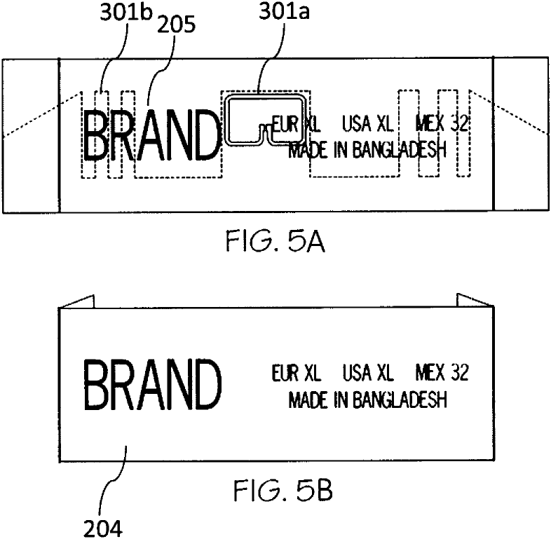

FIG. 5A illustrates a top view of a portion of substrate 204 in which the image 205 is printed. As can be made out, the image 205 is printed on the first side of the substrate and over the booster antenna 301b woven into the second side of the substrate. The image 205 is also printed within the register 401 (shown in FIG. 4A). As a result, it becomes possible to fold or cut the portion of roll of substrate (shown in FIG. 5B) without folding or cutting the portion of the antenna 301a (shown in FIG. 4A) or the booster antenna 301b (shown in FIG. 4A) and damage to the wireless communication device is prevented.

In many embodiments, the method of analyzing and adjusting a position of an image to be printed onto a substrate using the printer system is described herein. In many embodiments, a method of analyzing a printed image on a substrate comprises: (a) providing a printer system 100 comprising a position sensor 201, a motor and driver assembly 101 and an optical sensor 202; (b) feeding a substrate 204 integrated with at least a portion of a wireless communication device 301 including an antenna 301a into a printer 105 of the printer system 100; (c) printing an image on a first side of the substrate 204, opposite a second side of the substrate containing the antenna 301a and/or above the antenna 301a; (d) detecting a position of the wireless communication device 301 on the substrate using a location sensor 201 such as a capacitive sensor or an optical sensor 202; (e) detecting a previous alignment of the image printed with respect to the wireless communication device on the substrate, using the optical sensor 202 or a position sensor 201; and (f) adjusting alignment of a following image to be printed on the substrate by adjusting the position and/or speed of movement of the substrate as it passes through the printer system 100 based on a degree to which the printed image has moved too far forward or too far back relative to a position of the corresponding wireless communication device 301, thereby adjusting the position of print of the following image to be printed relative to its corresponding wireless communication device 301, the adjustment being made using the motor and driver assembly.

In many embodiments, the printed image may be at least partially disposed onto the substrate. In many embodiments, the substrate is a fabric material. In other embodiments, the substrate may be, paper, cardboard, laminate, polypropylene, polyester, aluminum, plastic, wood, or combinations thereof. In some embodiments, the substrate may be other types of plastics.

In many embodiments, the sensor is an optical sensor or a photocell sensor. In some embodiments, the vision sensor may be a video sensor. In many embodiments, the sensor may detect the presence and location of the wireless communication device. In many embodiments, if the sensor detects a print position of the indicia out of tolerance, then the printer may be stopped for significant adjustments more than 5 mm different. Otherwise for only small adjustments needed (those 5 mm and less), the printer may continue while these minor adjustments are made in-line by adjusting automatically the print position using the motor and driver system.

In some embodiments, the sensor further comprises sensor software. In many embodiments, the vision system software may check the position of the printout by evaluating its early or late phase shift.

In many embodiments, the print position for the wireless communication device and the printed image may be less than 5 mm off-center. In many embodiments, the print position for the wireless communication device and the printed image may be less than 3 mm off-center. In many embodiments, the print position for the wireless communication device and the printed image may be less than 2 mm off-center.

In many embodiments, the printed image may be analyzed and adjusted on a printer. In many embodiments, the printer may be in operation while the image is analyzed and adjusted. By adjusting the image while the printer is in operation, the production is not slowed.

In many embodiments, the method of analyzing a printed image onto a substrate comprising: providing a substrate, a printed image, and a wireless communication device, wherein the printed image is at least partially disposed on a first side of the substrate and wherein the wireless communication device is at least partially disposed on a second side of the substrate; and detecting a print position of the wireless communication device and the printed image using a sensor further comprises the step of adjusting the print position of the wireless communication device and the printed image. In some embodiments, the print position is adjusted when the wireless communication device and the printed image are more than 5 mm off-center. In some embodiments, the print position is adjusted when the wireless communication device and the printed image are more than 3 mm off-center. In some embodiments, the print position is adjusted when the wireless communication device and the printed image are more than 2 mm off-center.

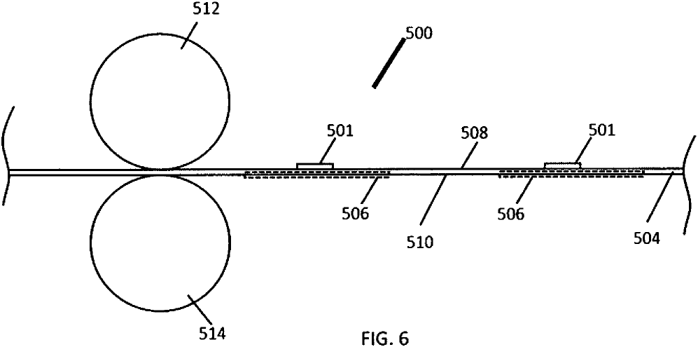

In some embodiments, such as in FIG. 6, a printing system may be configured to print on a substrate 504. FIG. 6 includes a printing system 500, a wireless communication device 501, a substrate 504 having a first side 508 and a second side 510, printed images 506, a printing roller 514, and an opposite roller 512.

In various embodiments, the printing system 500 is the same as or different from the printing system 100, and the wireless communication device 501 is the same as or different from the wireless communication device 301.

In some embodiments, the wireless communication device 501 is attached to the first side 508 of the substrate 504. The printed image 506 is disposed on the second side 510 of the substrate 504. In various embodiments, the printed image 506 is positioned based on its corresponding wireless communication device 501.

In various embodiments, the adjustment of the print position of the printed image 506 may be performed by adjusting the position of the substrate 504 with additional rollers (not shown) that pull the substrate 504 towards or away from the printing roller 514. In some embodiments, the print position of the printed image 506 may be adjusted by braking, stopping, shifting, rotating, accelerating, decelerating, speeding up, or slowing down one or more of the printing roller 514, the opposite roller 512, a roller contacting the substrate 504 after the printing has occurred using the printing roller 514 (not shown), and/or a roller contacting the substrate 504 before the printing has occurred using the printing roller 514.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

1. A printer system comprising:
a location sensor;
a motor and driver assembly configured for adjusting a print position of a subsequent image on a substrate having a first side and a second side and at least one wireless communication device; and
an optical sensor,
wherein adjustment of the print position is based on detection of the wireless communication device using the location sensor and a subsequent determination of whether the corresponding printed image is properly aligned with the wireless communication device using the optical sensor.

2. The printer system of claim 1, wherein the printed image is indicia comprising at least one word, a logo, a trademark, a design, a pattern, a graphic, an artwork, or combinations thereof.

3. The printer system of claim 1, wherein the substrate is a fabric material.

4. The printer system of claim 1, wherein the substrate comprises fabric, paper, cardboard, laminate, polypropylene, polyester, aluminum, plastic bags, wood, or combinations thereof.

5. The printer system of claim 1, wherein the first side of the substrate is on a side opposite to that of the second side of the substrate.

6. The printer system of claim 1, wherein the sensor comprises a capacitive sensor.

7. The printer system of claim 1, wherein the sensor comprises a photocell sensor.

8. The printer system of claim 1, wherein the sensor comprises an optical sensor.

9. The printer system of claim 1, wherein the sensor comprises a software based sensor.

10. The printer system of claim 1, wherein the wireless communication device comprises an RFID (radio frequency identification) device, a Near-Field Communication (NFC) device, a Bluetooth device, or combinations thereof.

11. The printer system of claim 10, wherein the RFID device comprises one or more antennas including a booster antenna woven into the substrate.

12. The printer system of claim 11, wherein at least one of the one or more antennas is coupled to an RFID chip.

13. The printer system of claim 1, wherein the wireless communication device is at least partially attached to the back side of the substrate by an adhesive.

14. The printer system of claim 1, wherein the wireless communication device is integrated into the substrate.

15. The printer system of claim 1, wherein the sensor, the motor and driver assembly and the optical sensor are installed on a printer of the printer system.

16. The printer system of claim 1, wherein the optical sensor is configured with predetermined specifications of the image to be printed.

17. The printer system of claim 1, wherein the optical sensor compares the previous alignment of the image printed with the predetermined specifications of the image to identify alignment or misalignment of the image with respect to the wireless communication device.

18. The printer system of claim 1, wherein the motor and driver assembly aligns the image with the wireless communication device and within the print register based on the identification of off-centering of the image with respect to the wireless communication device.

19. A method of adjusting a position of an image to be printed, with respect to a position of a wireless communication device on a substrate, the method comprising:
providing a printer system comprising: a location sensor, a motor and driver assembly, and an optical sensor;
feeding a substrate integrated with at least a portion of a wireless communication device including one or more antennas into a printer of the printer system;
printing an image on a first side of the substrate, the first side being opposite a second side of the substrate, the antenna being at least partially attached to the second side;
determining a position of the wireless communication device on the substrate using the location sensor;
determining alignment of the image printed with respect to the wireless communication device on the substrate using the optical sensor; and
adjusting alignment of a following image to be printed on the substrate using the motor and driver assembly.

20. The method of claim 19, wherein the printed image includes indicia comprising at least one word, a logo, a trademark, a design, a pattern, a graphic, an artwork, or combinations thereof.

21. The method of claim 19, wherein the substrate comprises a fabric material.

22. The method of claim 19, wherein the substrate comprises fabric, paper, cardboard, laminate, polypropylene, polyester, aluminum, plastic bags, wood, or combinations thereof.

23. The method of claim 19, wherein the sensor comprises an optical sensor.

24. The method of claim 19, wherein the sensor comprises a capacitive sensor.

25. The method of claim 19, wherein the sensor comprises a photocell sensor.

26. The method of claim 19 wherein the sensor comprises a software based sensor.

27. The method of claim 19, wherein the wireless communication device comprises RFID (radio frequency identification) device, Near-field communication (NFC), Bluetooth, or combinations thereof.

28. The method of claim 19, wherein the RFID device comprises one or more antennas including a booster antenna woven into the substrate.

29. The method of claim 19 wherein at least one antenna of the one or more antennas is coupled to a RFID chip.

30. The method of claim 19, wherein the wireless communication device is at least partially attached to the back side of the substrate by an adhesive.

31. The method of claim 19, wherein the wireless communication device is integrated into the substrate.

32. The method of claim 19, wherein the printed image is analyzed on a printer.

33. The method of claim 32, wherein the printer is in operation while the printed image is analyzed.

34. The method of claim 19, wherein the adjustment in the alignment of the following image to be printed is made when position of the wireless communication device and the printed image is off-center by less than 5 mm.

35. The method of claim 19 wherein the adjustment in the alignment of the following image to be printed is made when print position of the wireless communication device and the printed image is off-center by less than 3 mm.

36. The method of claim 19 wherein the adjustment in the alignment of the following image to be printed is made when print position of the wireless communication device and the printed image is off-center by less than 2 mm.

37. The method of claim 19, wherein the adjustment in the alignment of the following image to be printed is made when print position of the wireless communication device and the printed image is off-center by more than 5 mm.

38. The method of claim 19, wherein the adjustment in the alignment of the following image to be printed is made when the wireless communication device and the printed image are more than 3 mm off-center.

39. The method of claim 19 wherein the adjustment in the alignment of the following image to be printed is made when the wireless communication device and the printed image are more than 2 mm off-center.

40. The printer system of claim 16, wherein the optical sensor compares the previous alignment of the image printed with the predetermined specifications of the image to identify alignment or misalignment of the image with respect to the wireless communication device.
